(19) United States
(12) Patent Application Publication
(10) Pub. No.: US 2016/0016664 A1
(43) Pub. Date: Jan. 21, 2016

(54) UNMANNED AERIAL DELIVERY DEVICE

(71) Applicant: Umm Al-Qura University, Makkah (SA)

(72) Inventor: Jihad Talat Basuni, Makkah (SA)

(21) Appl. No.: 14/335,884

(22) Filed: Jul. 19, 2014

(51) Int. Cl. B64C 39/02; B64C 27/20; B60L 11/00; B64D 47/08; B64C 27/08; G05D 1/02

(52) U.S. Cl. CPC B64C 39/024; B64C 27/08; G05D 1/024; B60L 11/002; B64D 47/08; B64C 27/20; B64C 2201/042; B64C 2201/024; B64C 2201/108; B64C 2201/128

(57) ABSTRACT

An unmanned aerial delivery device has a plurality of rotors for propulsion and control, including redundant rotors in case of failure of a primary rotor, and uses a Laser Rangefinder system to guide the delivery device around an obstacle in its path until an acceptable straight-line path to a recipient is found, detect when a rotor is inoperable, and detect the distance from a take-off or landing surface to retract or extend support legs. The device has an insulated payload chamber that can only be opened by entering an unlock code on a touchscreen

### TECHNICAL FIELD

This invention relates generally to delivery devices for delivering items to customers, and more particularly to an unmanned aerial delivery device.

### BACKGROUND ART

Packages and other goods generally are delivered to consumers via land-based methods that require using a land-based vehicle to carry the goods to the consumer. This process is not cost efficient since generally even a single small package is frequently delivered by a motor vehicle that is much larger than would be required. Moreover, land-based systems are subject to road and traffic conditions, especially in congested areas, and delivery may take a considerable time.

Amazon has proposed a mini-drone delivery system that uses an unmanned aerial delivery vehicle that would be immune to road and traffic conditions and is claimed to be able to deliver small packages to consumers in just 30 minutes. The Amazon drone delivery system proposes the use of GPS guidance for its unmanned aerial vehicle.

Many other unmanned aerial vehicles, or drones, have been developed for a variety of purposes, including military and recreational uses. Drones have been proposed that have collision avoidance with other aerial vehicles. See, for example, U.S. Pat. No. 7,873,444 and published patent application 2010/0256909. Other drones have been developed that can be controlled with a cell phone. See, for example, U.S. Pat. No. 8,594,862. Still others have a camera and redundant propulsion. See, for example, the AscTec Falcon 8 multicopter developed by Ascending Technologies GmbH of Krailling, Germany.

Most of the drones available to date are designed for aerial surveillance or weapons delivery. The few that have been designed for delivery of consumer goods, such as the Amazon delivery drone, are limited in their navigation capabilities, especially their ability to avoid obstacles on the ground and plot new courses to their destination, or to protect the goods from the environment or provide means whereby only the intended recipient can access the goods.

It would be advantageous to have a delivery device for delivering small packages, documents, and other goods to consumers, wherein the delivery device has a navigation system that attempts multiple routes around an obstacle until an acceptable straight line path to the recipient is found.

It would also be advantageous to have a delivery device that has an insulated payload compartment for carrying items to maintain the goods at a desired hot or cold temperature, that protects the goods from the environment, and that can only be opened by the intended recipient using an unlock code provided by the sender.

It would be further advantageous to have a delivery device that has redundant propulsion means in the event of damage to or inoperability of one or more of the primary rotors; that has extensible and retractable legs for supporting the delivery device on a take-off or landing surface; and that uses a Laser Rangefinder system to guide the delivery device around an obstacle and to the recipient, detect when a rotor is inoperable, and to detect the distance from a take-off or landing surface to retract or extend the support legs.

### SUMMARY OF THE INVENTION

The present invention is a delivery device for delivering small packages and other goods to consumers, wherein the delivery device has:
a navigation system that attempts multiple routes around an obstacle until an acceptable straight line path to the recipient is found;
a payload compartment for carrying items to protect them from the environment, and that can only be opened by the intended recipient using an unlock code provided by the sender;
redundant propulsion means that become operative in the event of damage to or inoperability of one or more of the primary rotors;
extensible and retractable legs for supporting the delivery device on a take-off or landing surface; and
a Laser Rangefinder system to guide the delivery device around an obstacle, detect when a rotor is inoperable, and detect the distance from a take-off or landing surface to retract or extend the support legs.

The delivery device of the invention further has shields around the rotors to protect them from damage and to protect users from injury by the rotors, and also has a port for charging the battery without having to remove it from the delivery device. The delivery device also has a touchscreen for display of information and input of instructions, and an openable compartment for access to internal parts, such as, e.g., the battery.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a top isometric view of the delivery device according to the invention.

FIG. 2 is a bottom isometric view of the delivery device, showing the support legs in retracted positions.

FIG. 3 is a bottom isometric view of the delivery device, showing the support legs in extended positions.

FIG. 4 is a top isometric view of the delivery device, showing the lid for the payload compartment in an open position.

FIG. 5 is a side view in elevation of the delivery device, showing the port for attaching a battery charger, with the cover for the port in closed position.

FIG. 6 is a fragmentary enlarged view, looking from a slight angle from below, of the battery charging port with the cover open.

FIG. 7 is an inverted view of the delivery device, looking at a slight angle toward the bottom, showing the hanger and removable cover for gaining access to the interior of the delivery device.

FIG. 8 is an exploded inverted view of the delivery device, with the bottom cover removed.

FIG. 9 is a side view in elevation of the delivery device, showing the laser ports for detecting the distance to an object.

FIG. 10 is a top plan view of the delivery device, showing the forward-pointing array of guidance lasers.

FIG. 11 is a view looking up at a slight angle toward the bottom of the delivery device, showing the lasers for detecting distance during take-off and landing.

FIG. 12 is a diagrammatic view depicting the basic operation of the laser range finding system of the invention.

FIG. 13 is a schematic diagram showing the three main phases or levels of operation of the delivery device of the invention.

FIG. 14 is a top isometric view of one of the rotor assemblies of the invention, showing the laser for detecting whether the rotor is operating.

FIG. 15 is a top isometric view similar to FIG. 14, showing the rotor in a position to block the laser beam.

FIG. 16 is a top isometric view similar to FIG. 14, showing the rotor in a position not blocking the laser beam.

FIG. 17 is a graph showing the plot when a rotor is not rotating and is in a blocking position as depicted in FIG. 15.

FIG. 18 is a graph showing the plot when a rotor is not rotating and is in an unblocking position as depicted in FIG. 16.

FIG. 19 is a graph showing the plot when a rotor is rotating properly and is in alternate blocking and unblocking positions.

FIGS. 20A-20C show a flow chart identifying the sequence of steps for operation of the delivery device of the invention.

FIG. 21 is a schematic view showing how the delivery device of the invention is deployed in straight lines from a sender to recipients.

FIG. 22 is a schematic view depicting how a delivery device according to the invention moves to the left or right to get around an obstacle.

FIG. 23 is a schematic view showing the four distances from an obstacle the delivery device of the invention can take when maneuvering to avoid an obstacle in its path.

FIG. 24 is a schematic view showing a first example of a first case scenario wherein the delivery device approaches an obstacle to within 55 meters along a line extending through the centerline of the obstacle, and the obstacle has a depth of 50 meters and a width of 60 meters.

FIG. 25 is a schematic view showing an imaginary arc spaced 55 meters in front of the obstacle and extending from 0° to 90° on the left and right sides of the obstacle.

FIG. 26 is a schematic view showing how the delivery device first moves 90° toward the right side of the obstacle until a clear straight line path is available from the delivery device past the obstacle to the recipient when the delivery device is initially spaced 55 meters from the obstacle.

FIG. 27 is a schematic view similar to FIG. 26 depicting a second example of the first case scenario when the device approaches the obstacle on a line to the left of the obstacle centerline, and a clear straight line path is not available on the right side when the device has shifted 90° to the right.

FIG. 28 is a schematic view showing how the delivery device next moves 90° toward the left side of the obstacle until a clear straight line path is available from the delivery device past the obstacle to the recipient when a clear path is not available on the right side after the delivery device has moved 90° to the right.

FIG. 29 is a schematic view showing a third example of the first case scenario when the delivery device approaches the obstacle on a line to the left of the obstacle centerline, and the obstacle has a width of 70 meters.

FIG. 30 is a schematic view similar to FIG. 27 depicting how a clear straight line path is not available on the right side of an obstacle having a width of 70 meters when it is approached on a line to the left of the obstacle centerline and the device has approached the obstacle to a distance less than 30 meters from the obstacle when the device has shifted to the right.

FIG. 31 is a schematic view similar to FIG. 28, showing how the delivery device next moves 90° toward the left side of the 70 meter wide obstacle until a clear straight line path is available on the left side.

FIG. 32 is a schematic view similar to FIG. 23 of a fourth example of the first case scenario, showing the delivery device approaching the 70 meter wide obstacle along a line extending through the obstacle centerline.

FIG. 33 is a schematic view similar to FIG. 30, showing that a clear straight line path is not available from the delivery device past the right side of the obstacle under the conditions of FIG. 32 when the delivery device has moved 90° to the right.

FIG. 34 is a schematic view similar to FIG. 28, showing that a clear straight line path is not available from the delivery device past the left side of the obstacle under the conditions of FIG. 32 when the delivery device has moved 90° to the left.

FIGS. 35 and 36 are schematic views of a second case scenario wherein the delivery device has moved back 10 meters from the position in FIG. 32, so that it is spaced 65 meters from the obstacle having a width of 70 meters and a depth of 50 meters, and wherein an imaginary straight line from the delivery device to the intended recipient extends through the center of the obstacle.

FIG. 37 shows the delivery device moved 90° to the right side of the obstacle and it has found a clear straight line path to the recipient.

FIG. 38 depicts a second example of the second case scenario, wherein the delivery device is on a line extending through the centerline of an obstacle having a depth of 65 meters and a width of 70 meters, and the device is spaced 65 meters from the obstacle.

FIGS. 39 and 40 are schematic views showing how the device does not find a clear straight-line path to the recipient after shifting 90° to either the right side or the left side under the conditions of FIG. 38.

FIGS. 41 and 42 show a first example of a third case scenario wherein the delivery device is on a line extending through the centerline of the obstacle having a depth of 65 meters and a width of 70 meters, and the device has moved back an additional 15 meters to a distance of 80 meters from the obstacle.

FIG. 43 illustrates that the delivery device can find a clear straight line path to the recipient when the device has shifted 90° to the right under the conditions of FIG. 41.

FIG. 44 shows a second example of the third case scenario wherein the obstacle has both a depth and a width of 80 meters and the delivery device is spaced 80 meters from the obstacle on a line extending through the centerline of the obstacle.

FIGS. 45 and 46 depict how the obstacle cannot find a clear straight line path to the recipient on either the right side or the left side of the obstacle when the device has shifted 90° to either the right side or the left side under the conditions of FIG. 44.

FIGS. 47 and 48 depict a first example of a fourth case scenario wherein the delivery device has moved back an additional 20 meters to a distance of 100 meters from the obstacle along a line extending through the centerline of an obstacle having both a depth and width of 80 meters.

FIG. 49 shows how under the conditions of FIG. 47 the device can find a clear straight line path to the recipient on the right side of the obstacle.

FIG. 50 shows a second example of the fourth case scenario, wherein the device is spaced 100 meters from an obstacle on a line extending through the centerline of the obstacle, the obstacle has both a depth and a width of 80 meters, and the recipient is located relatively close to the rear of the obstacle.

FIG. 51 shows how the device can find a clear straight-line path to the recipient on the right side of the obstacle after the device has shifted 180 degrees to the right under the conditions of FIG. 50.

FIG. 52 shows a third example of the fourth case scenario, wherein the delivery device has approached an obstacle along a line to the left of the centerline of the obstacle at which position the device is spaced 100 meters from the obstacle, and the obstacle has both a depth and a width of 80 meters.

FIG. 53 shows that a clear straight line path to the recipient does not exist on the right side of the obstacle under the conditions shown in FIG. 52 when the delivery device has shifted to the right and has come within a distance less than 30 meters from the obstacle.

FIG. 54 shows that there is a clear straight line path to the recipient around the left side of the obstacle under the conditions shown in FIGS. 52 and 53 when the delivery device moves to the left 180°.

### DETAILED DESCRIPTION OF THE PREFERRED EMBODIMENTS

A delivery device according to the invention is indicated generally at 10 in FIGS. 1-11 and 14-16. The delivery device comprises a body 11 with eight rotors 12 spaced uniformly around its periphery. Each rotor is mounted at the end of a respective radially extending support arm 13, and each rotor is surrounded by a respective annular shield 14 to protect the rotors from damage and to protect a user of the delivery device from being injured by the rotors.

The rotors include a primary group of four, e.g. rotors 12a, 12c, 12e and 12g, that operate the device in the normal mode of operation and a secondary group of four redundant rotors, e.g. rotors 12b, 12d, 12f and 12h, that operate in case of damage or inoperability of one or more of the primary rotors.

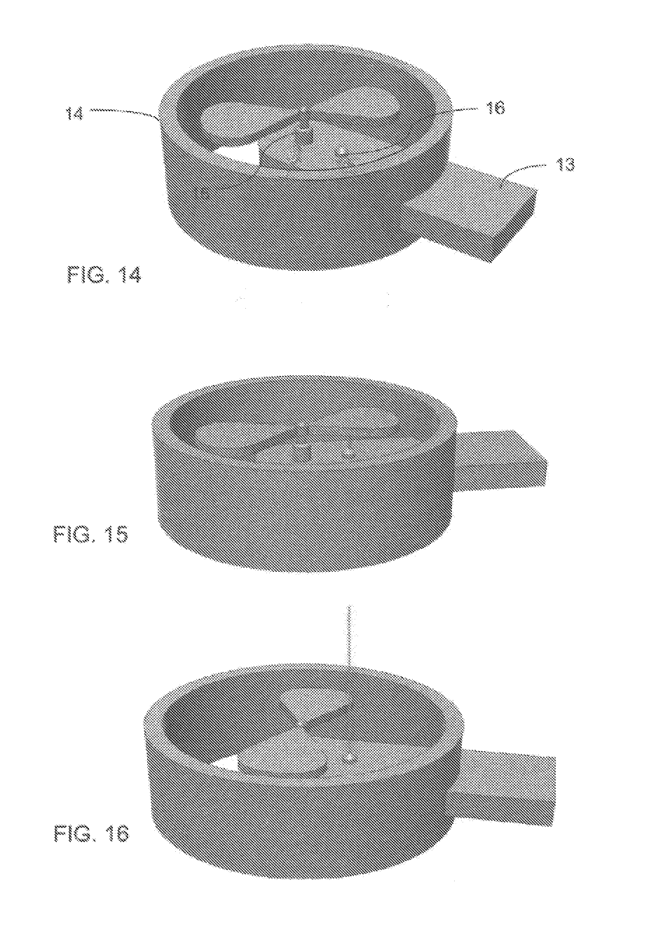

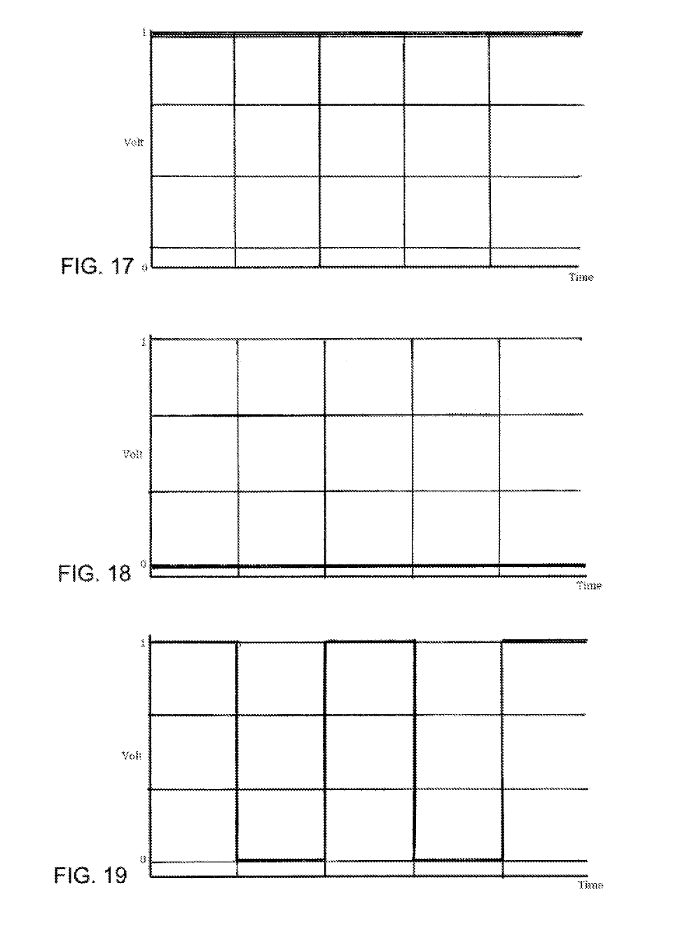

As seen best in FIGS. 14-16, each rotor has its own motor 15 and a laser 16 that directs a laser beam upwardly through the plane of rotation of the rotor. As long as a rotor is functioning properly the laser beam will be periodically reflected to produce a pulsed signal as depicted in FIG. 19. However, if a rotor is damaged or otherwise inoperable and the rotor is stopped to block the beam as shown in FIG. 15 for a predetermined period of time a steady signal will be produced as shown in FIG. 17, or if the rotor is stopped in a position to not block the beam, as shown in FIG. 16, a steady signal will be produced as shown in FIG. 18. Under either of these conditions there is no pulsed signal and the onboard electronics will activate one or more of the redundant rotors as necessary to operate and maintain control of the delivery device.

A cylindrical payload chamber 17 is recessed into the top side of the body 11 and a dome-shaped cover 18 is hinged to the body 11 for movement into and out of closing relationship to the payload chamber. The cover is locked in closed position by a latch (not shown) that is released upon entry of a code in touchscreen 19. The payload chamber and cover preferably are insulated with a suitable insulating material such as extruded polystyrene foam, for example, having a thickness of about 1 cm, for example, to maintain the chamber and items in it at a desired hot or cold temperature.

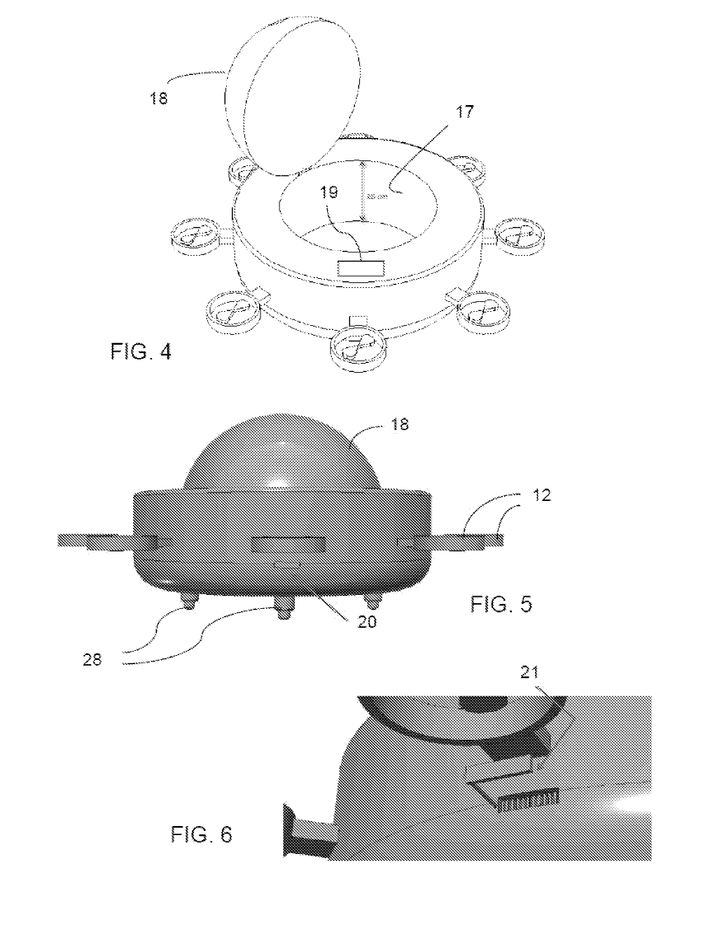

Power for the delivery device is derived from an onboard battery, preferably a high-performance lithium-ion battery, and as shown in FIGS. 5 and 6 a charging port 20 is provided for plugging in a battery charger. A movable cover 21 is positioned to cover the port during operation and may be moved to gain access to the port when it is desired to charge the battery.

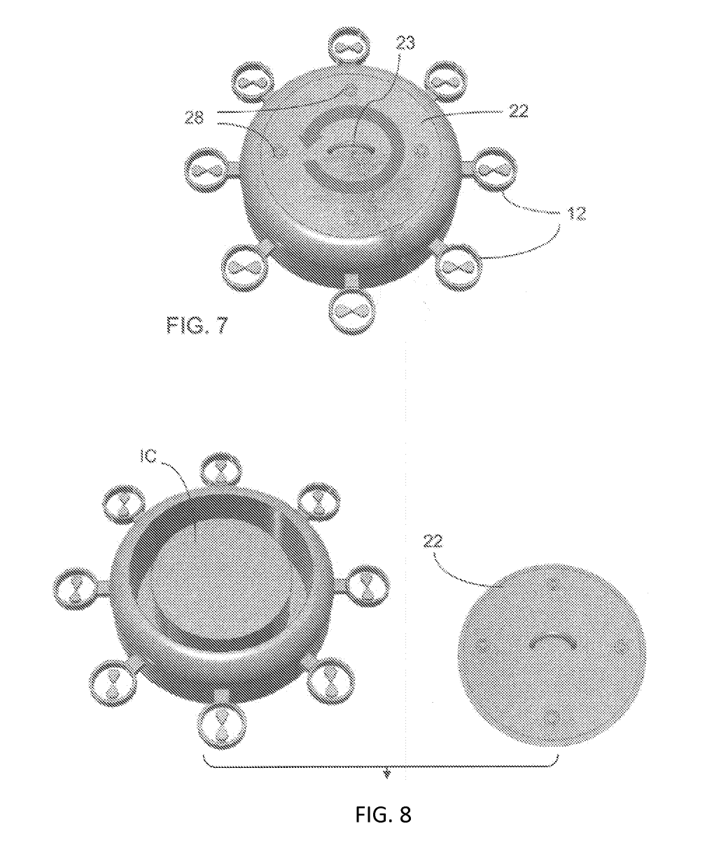

As shown in FIGS. 7 and 8, a removable bottom cover 22 is positioned on the bottom of the delivery device to permit access to the internal components IC, including the battery, when desired or necessary. A hanger 23 depends from the center of the bottom cover 22 and objects that are too large to fit in the payload chamber may be suspended from it. In one construction of the invention, the cover is rotated to remove it and the hanger may be used to rotate the cover. Alternatively, the cover may be secured in place by screws, bolts, or other suitable means, not shown.

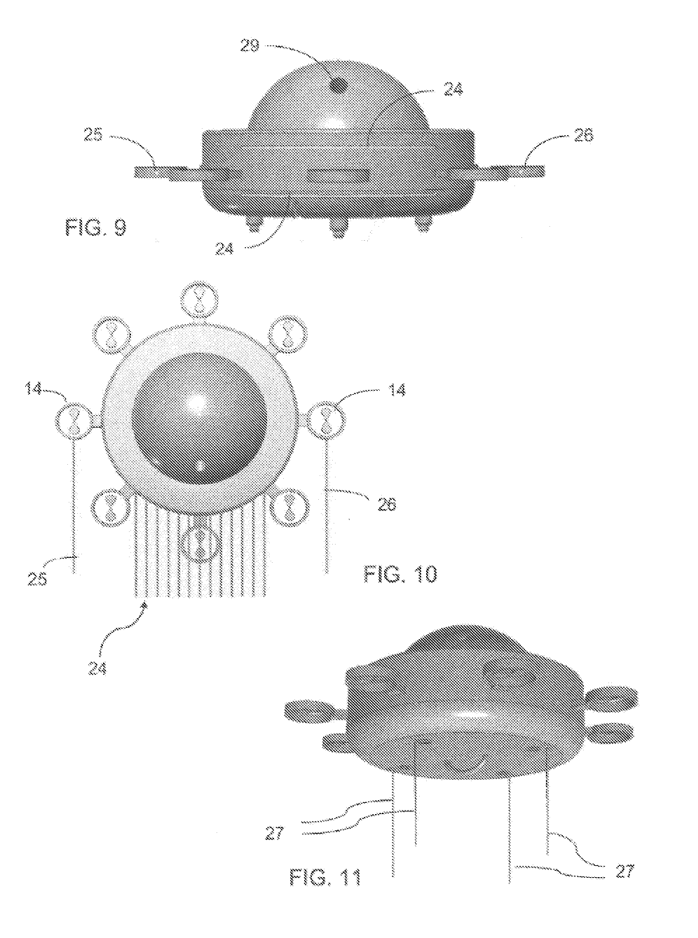

FIGS. 9 and 10 show an arrangement of lasers that are used to detect objects in the path of the delivery device. It operates on the time of flight principle by sending laser pulses in a narrow beam toward the object and measuring the time taken by the pulses to be reflected off the target and returned to the sender S. The lasers include an array of forwardly facing lasers 24 in the forward side of the delivery device, and a forwardly facing laser 25, 26 in respective rotor shields 14 on opposite sides of the delivery device. The onboard electronics uses the reflected signals from these lasers to determine the distance from the object and operate the delivery device as explained more fully hereinafter.

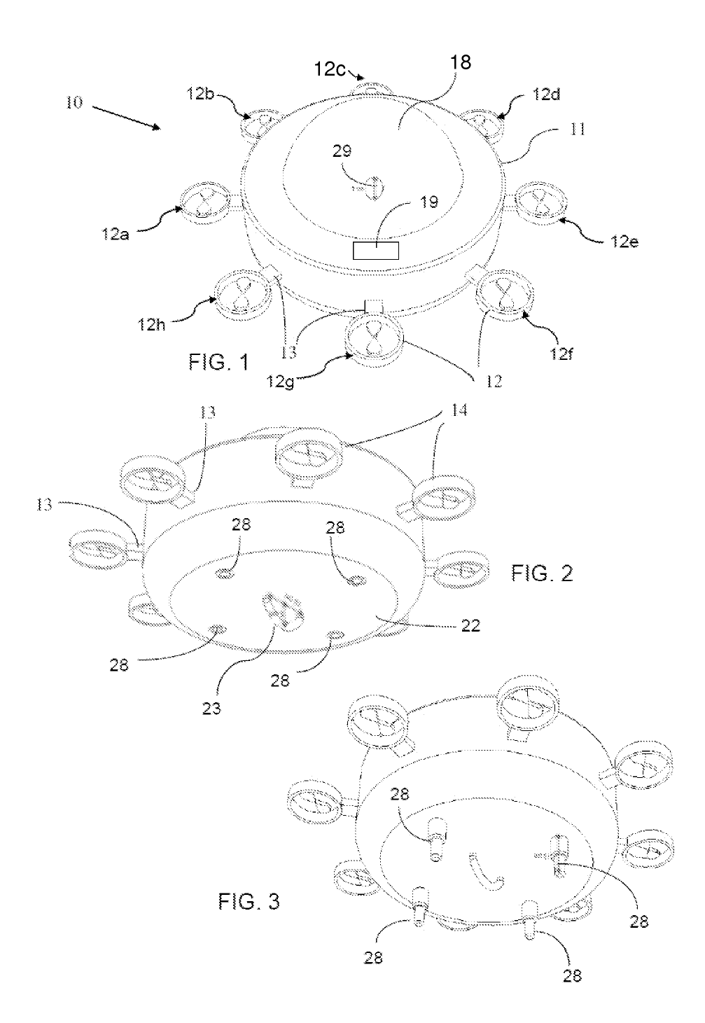

As shown in FIG. 11, downwardly facing lasers 27 in the bottom of the delivery device detect the distance from a takeoff or landing surface, and through the onboard electronics control the extension and retraction of support legs 28 in the bottom of the delivery device. In operation, the legs are normally extended to the position shown in FIG. 3 when the delivery device is resting on a support surface and after takeoff until the delivery device reaches a height of about two meters. The onboard electronics then retracts the legs to the position shown in FIG. 2 where they remain until the delivery device lowers to a height of about two meters from the landing surface during landing, at which time the legs are again extended by the onboard electronics. Each leg has an associated laser 27 (see FIG. 11) and the length to which each leg is extended can be controlled to accommodate an uneven surface as detected by the lasers and onboard electronics.

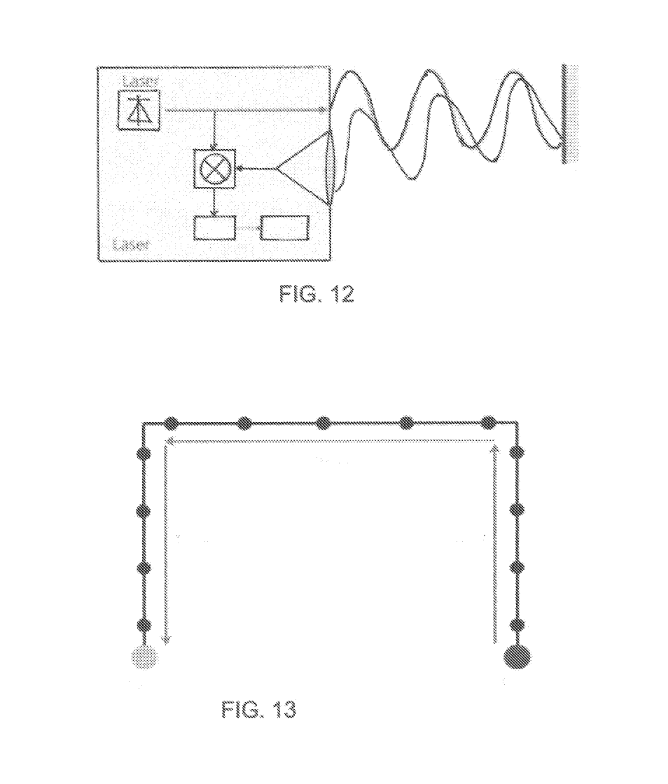

FIG. 12 is a schematic showing the laser beams being projected outwardly toward a surface and being reflected back to a pulse detector P. A distance converter DC calculates the distance to the surface based on how long it takes the reflected signals to return.

A camera 29 is mounted on the delivery device to transmit a real-time image of the flight path to the sender's smartphone, iPad, computer, or other device to allow the sender to observe conditions along the flight path.

The touchscreen 19 is placed on an appropriate part of the delivery device, such as on the annular space between the dome-shaped cover and the outer periphery of the delivery device body, for example. The touchscreen displays data such as maps, weather conditions, location of the recipient, state of battery charge, etc. It can also display video recorded by the camera during flight, and can be used to write a message to the recipient R, to enable the sender S to choose whether the delivery device is being sent roundtrip or one-way, and for the recipient R to input a code to open the cover for the payload chamber. A speaker, not shown, is associated with the touchscreen and is covered for protection during flight.

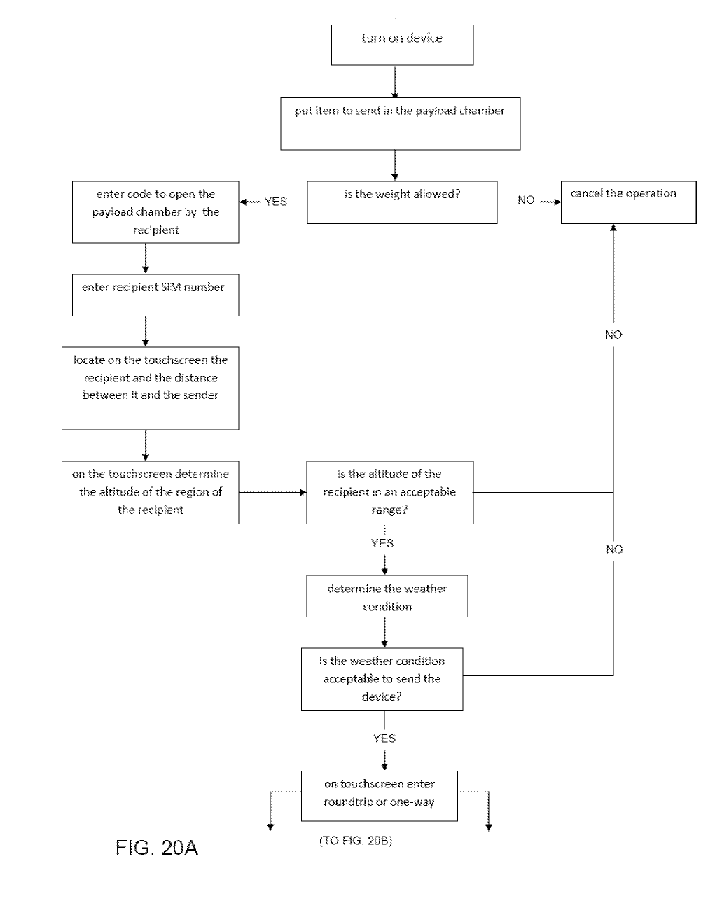

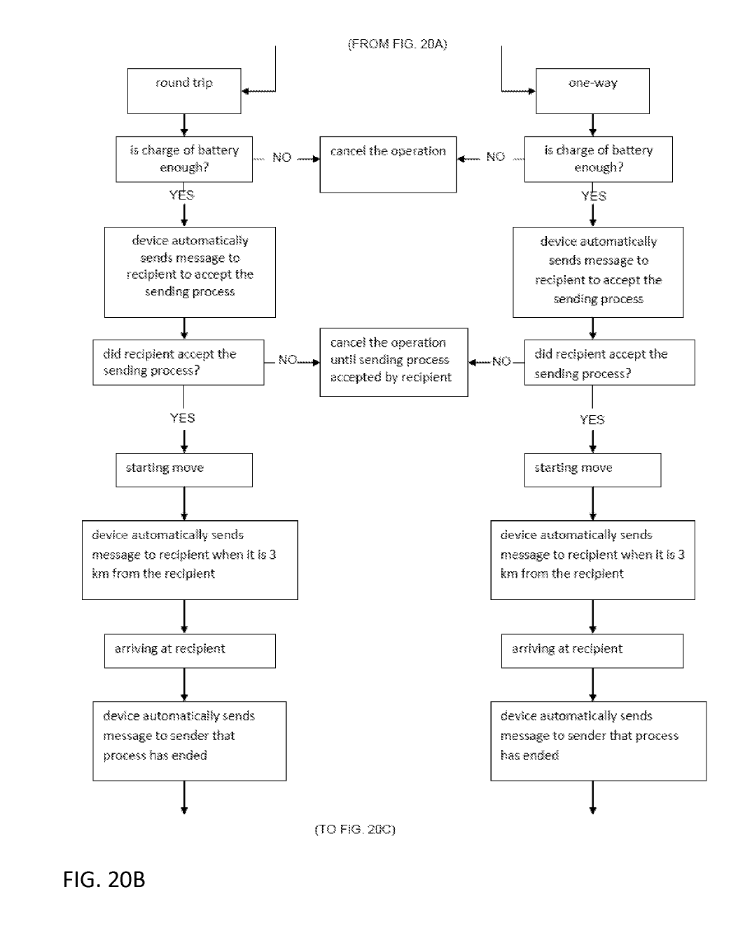

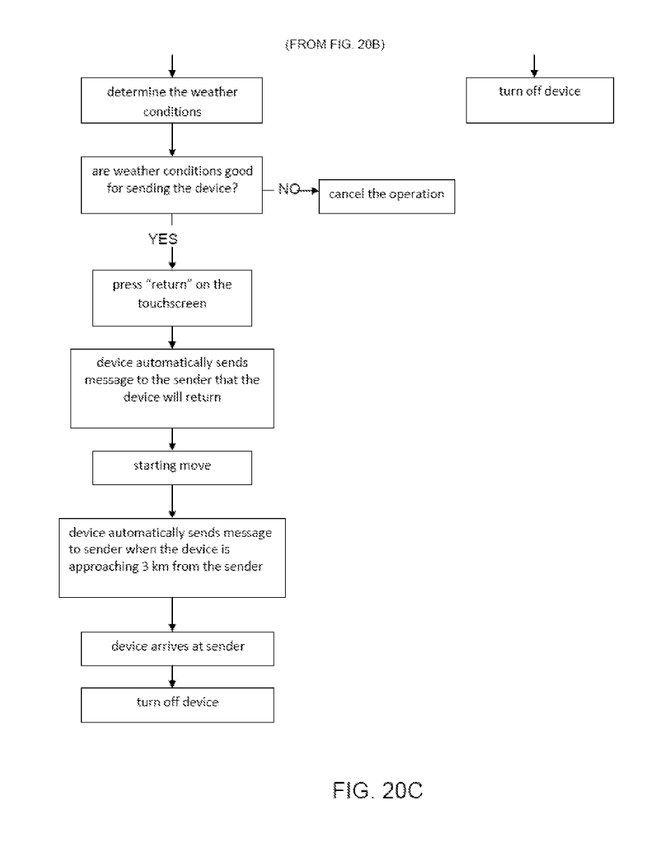

As depicted in FIG. 13, the delivery device has three main phases of operation: take-off; flying in a straight line to the recipient R; and landing. During the delivery phase the device will fly at a specified height in a straight line to the recipient R, as depicted schematically in FIG. 20. If the recipient R is in a place higher than the allowed rate of rise for the device, a message will appear on the screen and the device will not move.

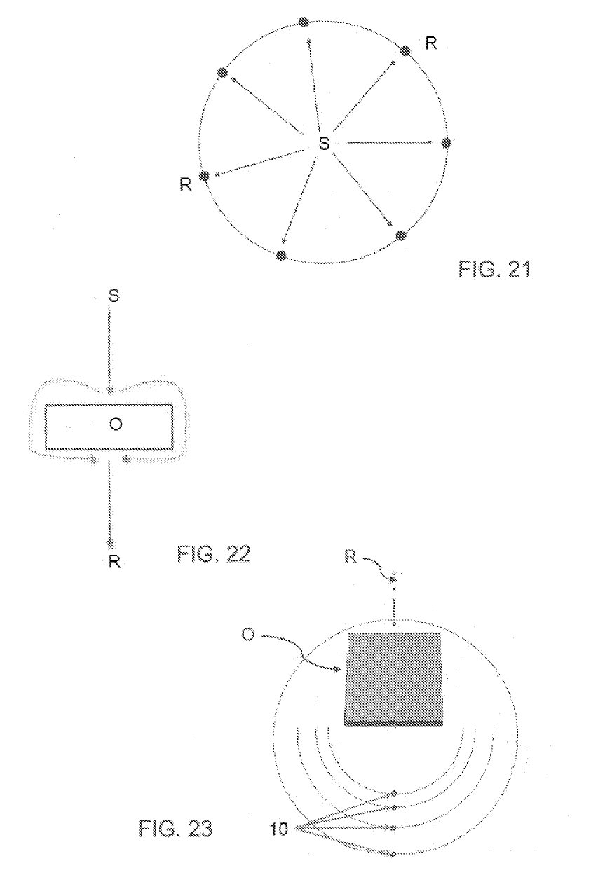

Under normal operation, if the device encounters an obstacle such as, e.g., a high building, between it and the recipient it is programmed to make four attempts to get around the obstacle as explained more fully hereinafter and if is unsuccessful it will return to the sender. In the first case the device stops a distance of 55 meters from the obstacle and crosses from side-to-side of the obstacle through an angle of 90° from one side to the other, as depicted in FIG. 22, until it finds a clear straight line path to the recipient. If it fails to find a clear straight line path in the first case, it moves to the second case wherein the device moves back 10 meters to a distance 65 meters from the obstacle and again moves from side-to-side through an angle of 90° to either side in an attempt to find a clear straight line path to the recipient. If it fails to find a clear straight line path to the recipient in the second case it moves to a third case spaced back another 15 meters to a distance spaced 80 meters from the obstacle and again moves from side-to-side through an angle of 90° to either side in an effort to find a clear straight line path to the recipient. If it fails to find a clear straight line path to the recipient in the third case it moves to a fourth case spaced back another 20 meters to a distance spaced 100 meters from the obstacle but this time it moves from side-to-side through an angle of 180° in an effort to find a clear straight line path to the recipient. If it fails to find a clear straight line path to the recipient in all four cases the device returns to the sender.

As used herein, “normal operation” means the device will begin at the first case and advance through the second, third and fourth cases, as necessary. In every case the device will check on the right side of the obstacle first and will then check the left side if nothing is available on the right side. The sender can change the normal operation so the device begins, for example, at the third case and then advances to the fourth case if necessary.

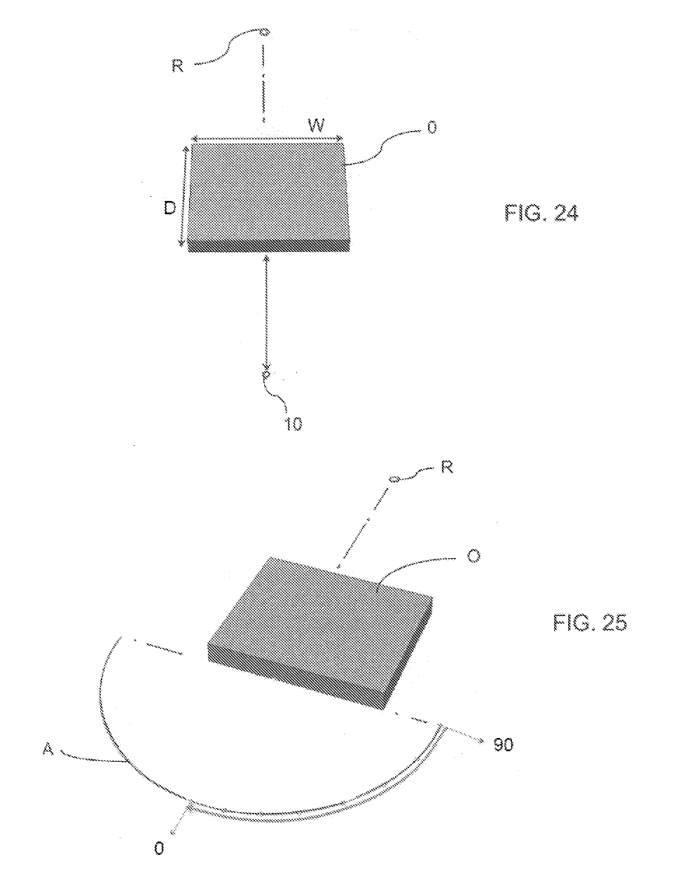

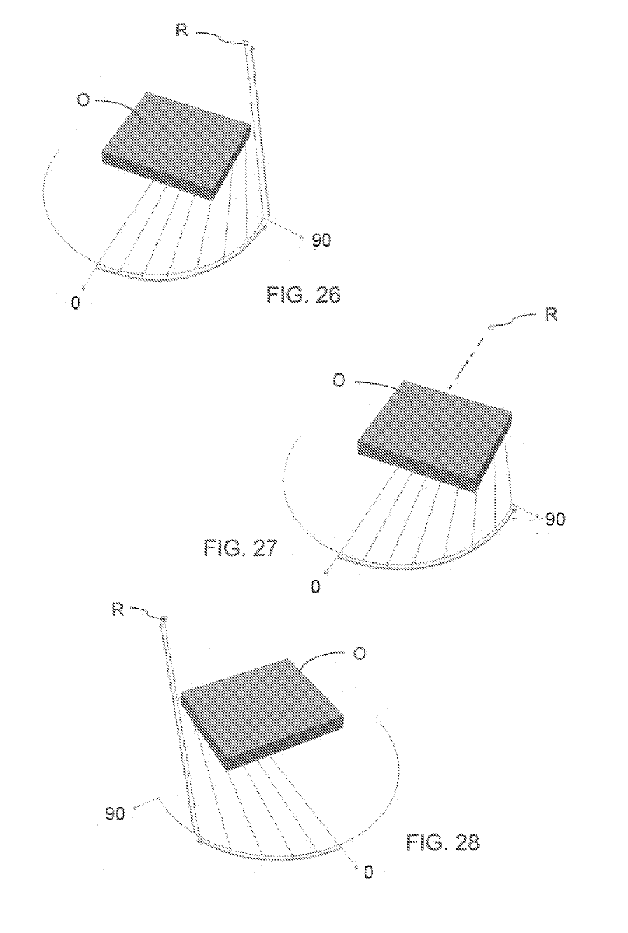

A first example of a first case scenario is depicted in FIGS. 24-26, wherein the delivery device approaches an obstacle O to a distance of 55 meters along a line extending through the centerline of the obstacle, and wherein the obstacle has a depth D of 50 meters and a width W of 60 meters. As shown in FIG. 26, the device finds a clear straight line path to the recipient R when the device shifts 90° to the right.

In a second example of the first case scenario as shown in FIGS. 27 and 28, the delivery device approaches the obstacle O on a line to the left of the obstacle centerline, and with the other conditions of FIG. 24 remaining constant, the device is unable to find a clear straight line path to the recipient when the device shifts to the right, as shown in FIG. 27, but when it shifts 90° to the left as shown in FIG. 28 it does find a clear straight line path to the recipient.

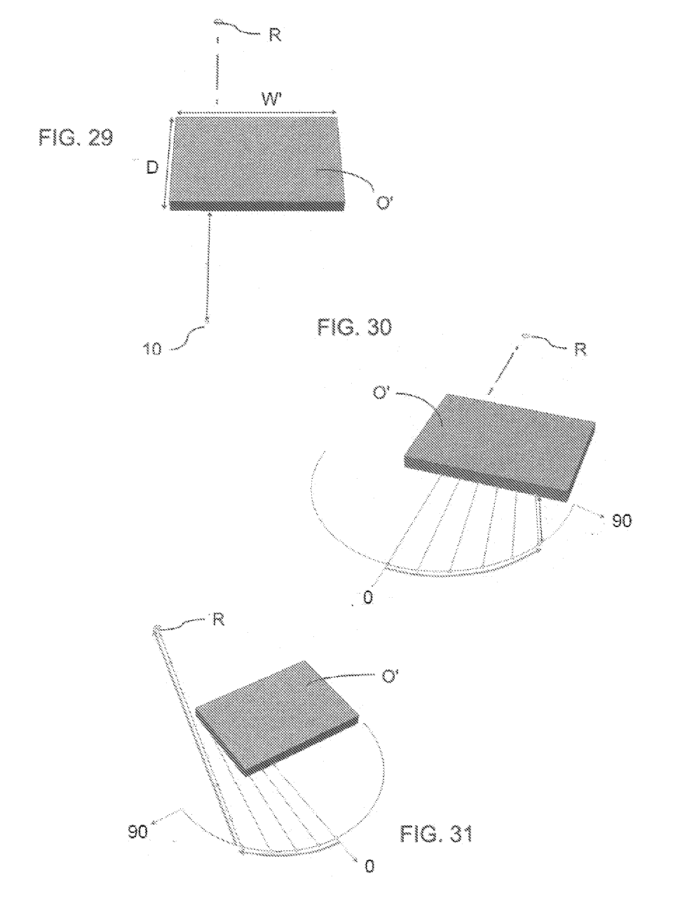

In a third example of the first case scenario, shown in FIGS. 29-31, the obstacle has a depth D of 50 meters and a width W′ of 70 meters and the delivery device approaches the obstacle along a line to the left of the centerline of the obstacle to a distance of 55 meters from the obstacle. Under these conditions, if when the device shifts to the right side of the obstacle and comes to within a distance of less than 30 meters from the obstacle without finding a clear straight line path to the recipient, as shown in FIG. 30, it will stop looking on that side and will shift to the left, as shown in FIG. 31, where it does find a clear straight line path to the obstacle. In this regard, if at any angle during its shift the device comes to within a distance less than 30 meters from the obstacle and does not find a clear straight line path to the recipient, it will stop searching on that side and will shift to the other side. This precaution ensures the safety of the device and takes into consideration wind conditions which could blow the device into the obstacle if it approaches closer than about 30 meters.

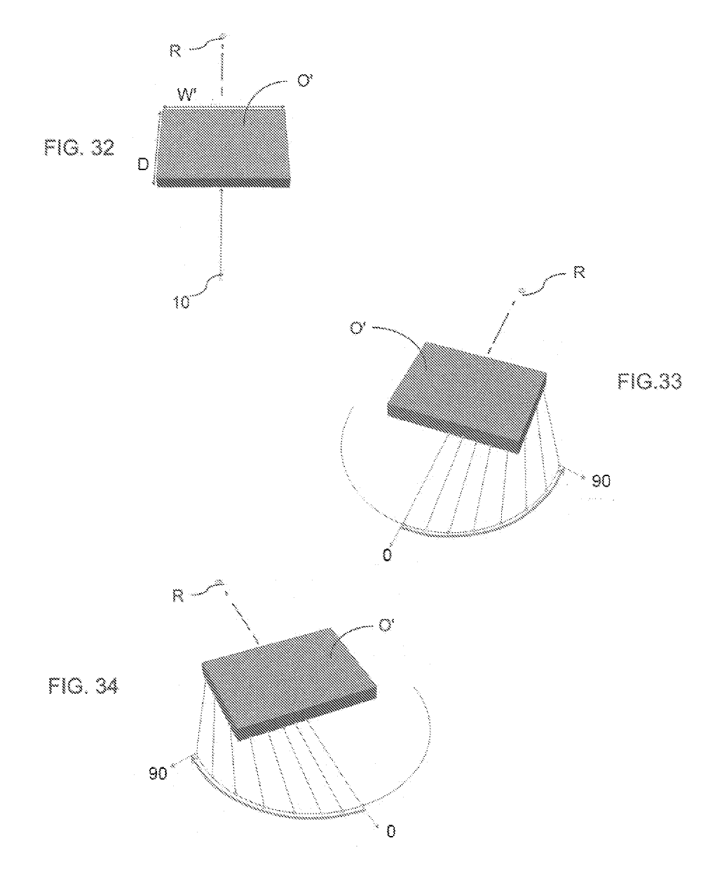

In a fourth example of the first case scenario, shown in FIGS. 32-34, the obstacle O′ has a depth D of 50 meters and a width W′ of 70 meters and the delivery device approaches the obstacle to a distance of 55 meters from the obstacle along a line extending through the centerline of the obstacle. Under these conditions, the device is unable to find a clear straight line path to the recipient when the device shifts 90° to the right or the left as shown in FIGS. 33 and 34, respectively.

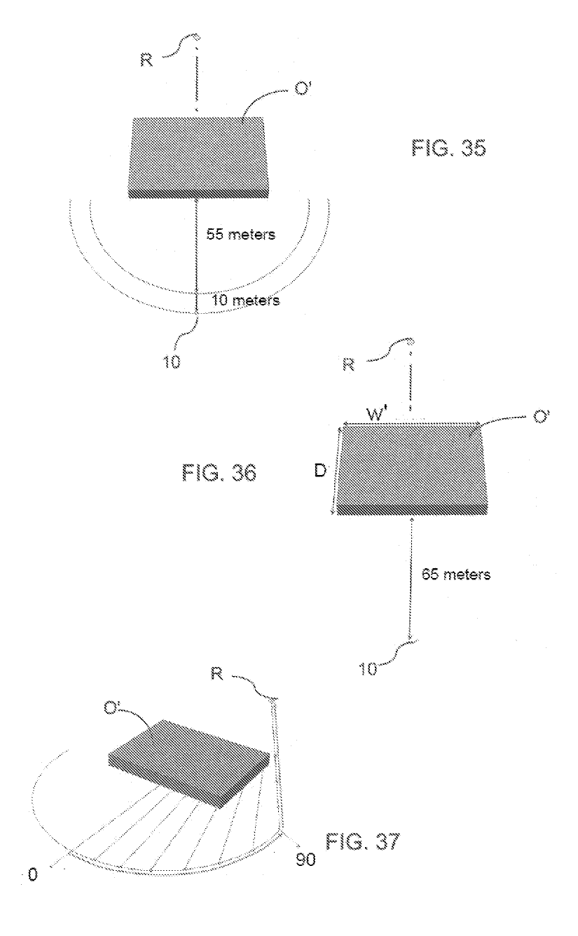

When the device is unable to find a clear straight line path to the recipient under the first case scenario where the delivery device is spaced 55 meters from the obstacle under the conditions of FIGS. 32-34, the device moves back 10 meters to a distance of 65 meters from the obstacle O′ under a second case scenario as shown in FIG. 35.

In a first example under the second case scenario, when the device approaches the obstacle O′ along a line passing through the centerline of the obstacle, as shown in FIG. 36, the device will first shift through an angle of 90° on the right side as shown in FIG. 37 and will find a clear straight line path to the recipient on the right side.

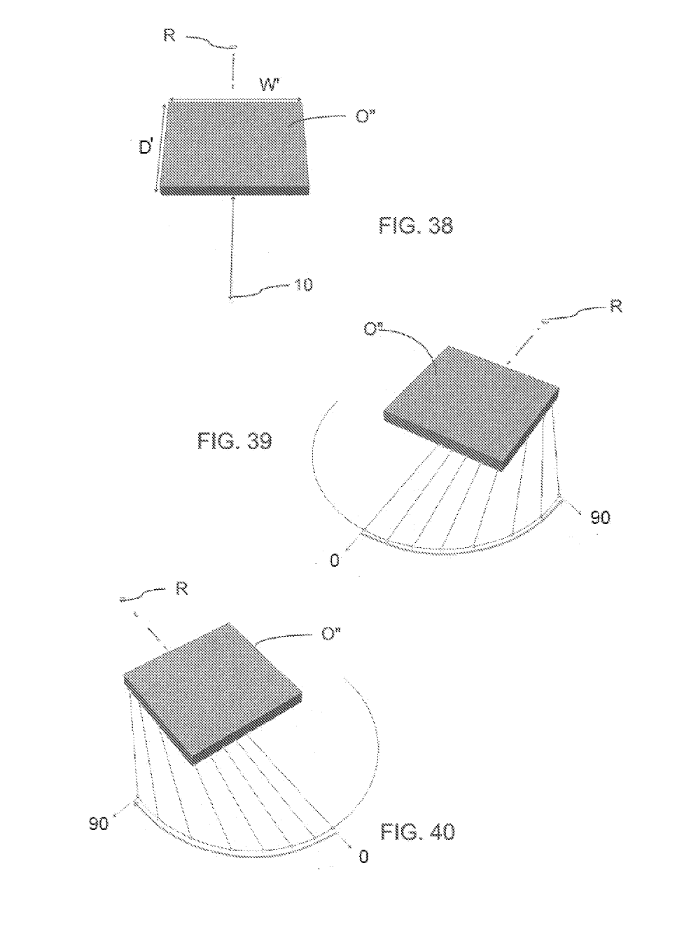

In a second example under the second case scenario, shown in FIGS. 38-40, the obstacle O″ still has a width W′ of 70 meters but it now has a depth D′ of 65 meters. If the delivery device approaches to a distance of 65 meters from the obstacle along a line that extends through the centerline of the obstacle, it is unable to find a clear straight line path to the recipient on either right or the left side, as depicted in FIGS. 39 and 40.

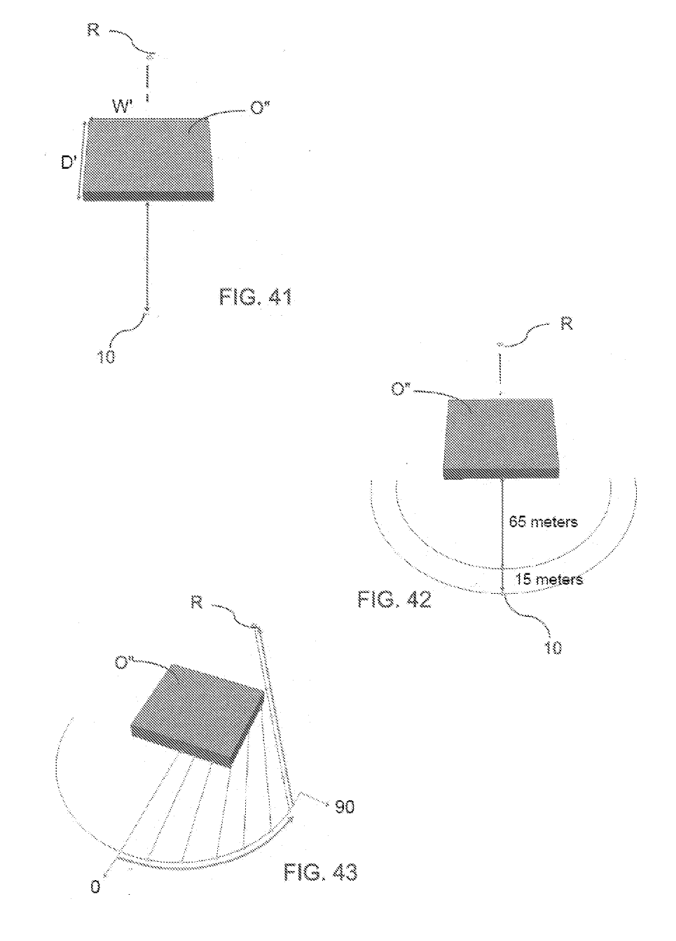

Failing to find a clear straight line path to the recipient on either the right or the left side under the conditions of the second example, second scenario, the delivery device will back up an additional 15 meters to a distance of 80 meters from the obstacle to a third case scenario as shown in FIGS. 41 and 42.

If, under the conditions of the third case scenario, the device approaches an obstacle O″ along a line extending through the centerline of the obstacle, as shown in FIG. 41, it will find a clear straight line path to the recipient after it has shifted 90° toward the right side of the obstacle as shown in FIG. 43.

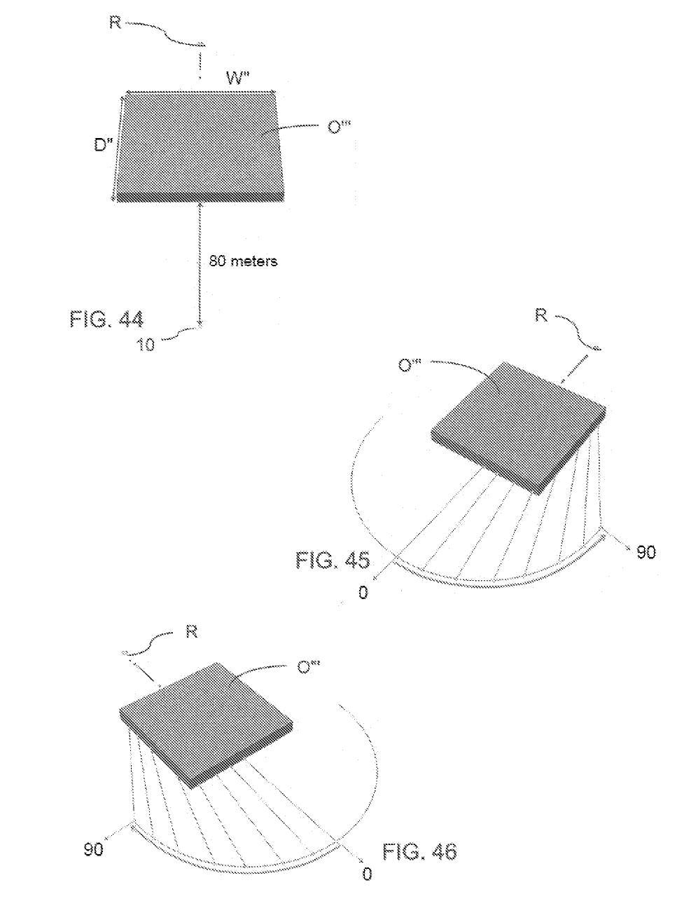

In a second example under the third case scenario, the obstacle O′″ has both a depth D″ and a width W″ of 80 meters. When the device approaches the obstacle O′″ along a line extending through the centerline of the obstacle, as shown in FIG. 44, it will not be able to find a clear straight line path to the recipient when the device shifts 90° to either the right side or the left side as shown in FIGS. 45 and 46, respectively.

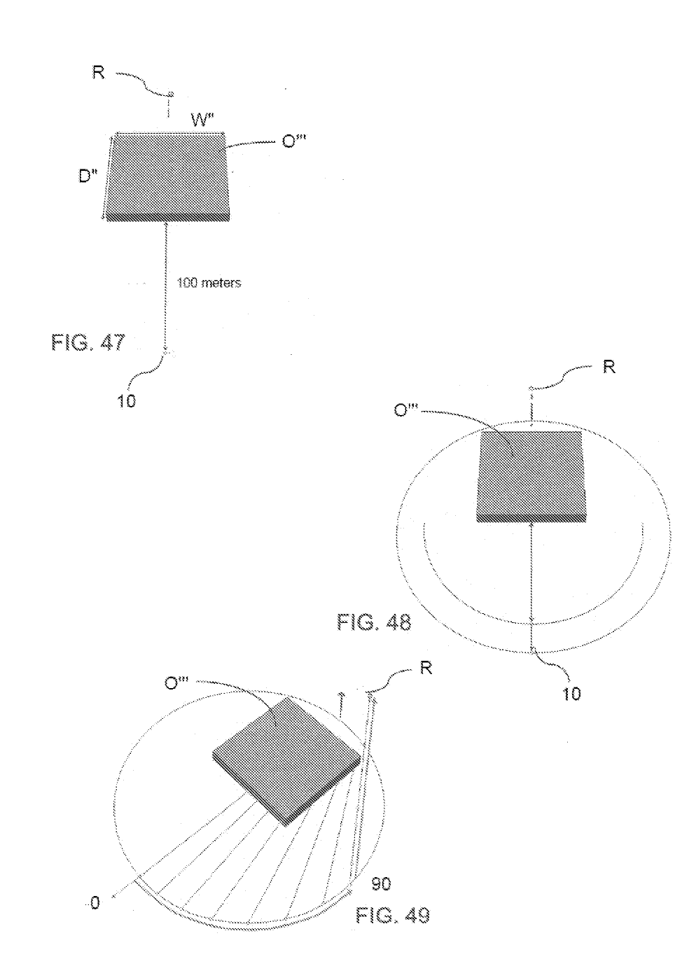

When the device is unable to find a clear straight line path to the recipient under the conditions of the second example of the third case scenario as discussed above, it will move to a fourth case scenario wherein it backs up an additional 20 meters to a distance of 100 meters from the obstacle O′″, as shown in FIGS. 47 and 48. Under these conditions, when the delivery device shifts 90° to the right it will find a clear straight line path to the recipient, as shown in FIG. 49.

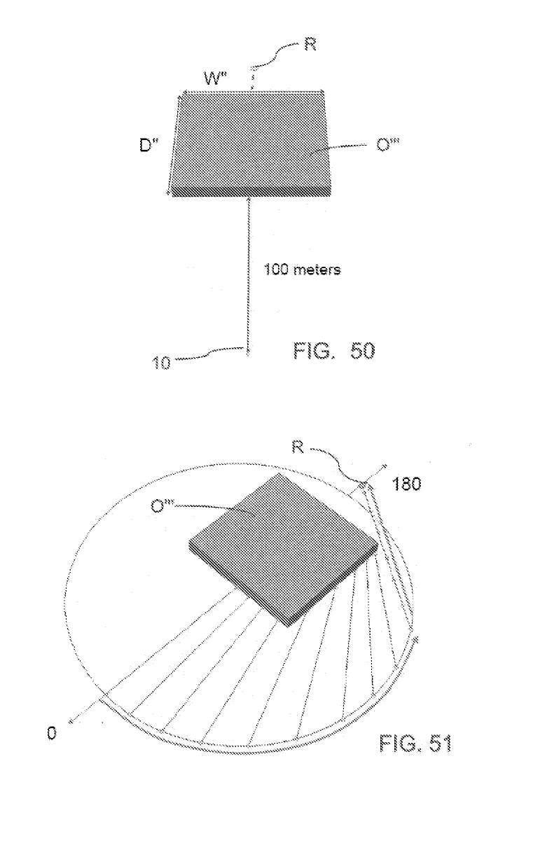

FIGS. 50 and 51 show another example of the fourth case scenario wherein the delivery device is spaced 100 meters from the obstacle. In this example, the recipient R is not spaced very far from the rear of the obstacle O′″ and to find a clear straight line path to the recipient the device shifts 180° to the right as shown in FIG. 51.

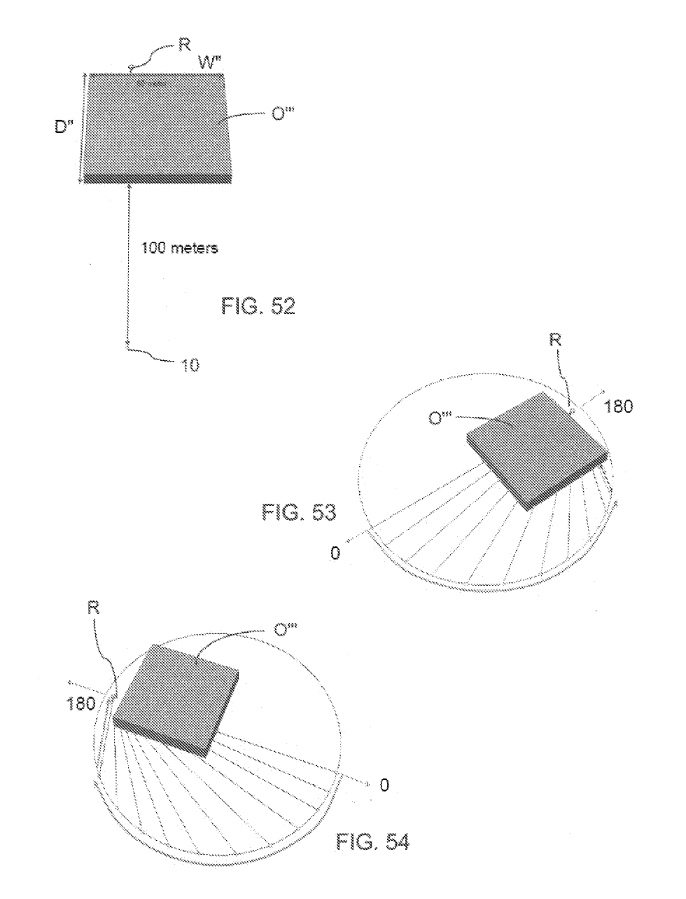

A further example of the fourth case scenario is shown in FIGS. 52-54, wherein the device approaches the obstacle O′″ along a line to the left of the centerline of the obstacle, as shown in FIG. 52. In this case, when the delivery device shifts to the right it comes within a distance less than 30 meters from the obstacle without finding a clear straight line path to the recipient. In this case, it will stop searching on the right side and will shift 180° to the left, where it does find a clear straight line path as shown in FIG. 54.

Upon arrival at the recipient, the device will stop a predetermined distance, e.g. 30-40 cm, from the recipient. The recipient will then retrieve the delivered items from the payload chamber, which will not open until the recipient enters the appropriate code on the touchscreen. The amount of battery charge will be displayed on the screen, and if the charge is enough to return to the sender S, the recipient will return it. If not enough, the recipient will recharge the battery before returning the device to the sender.

The sender S or owner of the device can control the device remotely by SIM card. The device has its own SIM card and unique ID number. The recipient can be located by mobile phone number and GPS. There are two methods to control the device remotely by SIM card:
1) By Short Message Service (SMS).
The sender or owner of the device will enter a special code to perform a particular task. For example:

| Code | job |
|---|---|
| 1234 | Cancel operation |
| CN | Turn on camera |
| CF | Turn off camera |

If the sender wants to cancel an operation, he will send SMS message code “1234” to the SIM card number of the device. The device will receive this message and cancel the operation. This method of control does not require the Internet.
2) By the Internet:
Since the device has its own SIM card, the sender or owner of the device can control the device remotely by 3G or 4G networks using a laptop, cell phone or other device. The laptop, cell phone or other device would have an application for this purpose.

When the sender enters the number of the recipient, the device can determine the time it will take the device to reach the recipient, depending upon the speed of the device and the distance to the recipient. There are three conditions under which this information is important:
1) The charge on the battery is enough to deliver the device but not to return it, unless the recipient recharges the battery. In this case, that information will be displayed on the touchscreen, and the device will move only with the consent of the sender.
2) The charge on the battery is enough to deliver the device and return it. In this case, that information will be displayed on the touchscreen, and the device will move only with the consent of the sender.
3) The charge on the battery is not enough to deliver the device to the recipient. In this case, that message will appear on the touchscreen and the device will not move.

In a preferred embodiment, the touchpad displays the following items:
1) Through this screen, the sender can insert the recipient's number;
2) Through this screen, the sender can write a massage to the recipient;
3) Through this screen, the sender can choose whether to send the device roundtrip or one-way;
4) Through this screen, the recipient can insert the security code to open the payload chamber;
5) Maps and the location of the recipient;
6) The weather;
7) The battery charge level; and
8) A video, which was recorded during flight

In an example of a particular construction of the device the rotor blades each have an overall length of about 14 cm and are encircled by a protective ring having a diameter of about 15 cm and a height of about 6 cm. The shafts supporting the rotors and protective rings on the main housing have a length of about 5 cm and a width and height of about 3 cm. The housing has a diameter of about 80 cm and a height, not counting the chamber for carrying the payload, of about 30 cm. The overall diameter of the device, including the rotors and their protective shields, is about 120 cm. The payload chamber, located in the center of the main housing, has a diameter of about 50 cm and extends into the main housing a depth of about 25 cm.

While particular embodiments of the invention have been illustrated and described in detail herein, it should be understood that various changes and modifications may be made in the invention without departing from the spirit and intent of the invention as defined by the appended claims.

What is claimed is:

1. An unmanned aerial delivery device for delivering items from a sender to a recipient, wherein the device flies to the recipient along a straight line path from the sender to the recipient, said device comprising:
a body having a payload chamber therein for containing items to be delivered to a recipient;
a plurality of rotors attached to the body around its periphery, said rotors including a number of primary rotors for normal operation of the device, and a number of redundant rotors to operate the device in the event of damage to or inoperability of one or more of the primary rotors; and
range-finder means on said device for detecting obstacles in the path of the device and guiding the device around the obstacle to maintain the straight line path to the recipient.

2. The delivery device as claimed in claim 1, wherein:
said range-finder means comprises forwardly pointing lasers on the device.

3. The delivery device as claimed in claim 2, wherein:
said rotors are supported on the ends of support arms mounted to said body; and
an annular rotor shield extends around each said rotor to protect the rotors from damage and to protect a user of the device against injury from the rotors.

4. The delivery device as claimed in claim 2, wherein:
said forwardly pointing lasers are mounted on said body and on at least two of said rotor shields.

5. The delivery device as claimed in claim 4, wherein:
a separate motor is associated with each rotor for rotating the rotor.

6. The delivery device as claimed in claim 5, wherein:
each said rotor has a laser positioned to project its beam through the plane of rotation of the rotor so that pulses are generated when the rotor is rotating properly and when a rotor is not rotating no pulses are generated, said lasers being connected with electronics on board said device to activate one or more of said redundant rotors when one or more of said rotors is not operating properly.

7. The delivery device as claimed in claim 6, wherein:
legs are on the bottom of said device to support the device on a surface.

8. The delivery device as claimed in claim 7, wherein:
at least one downwardly pointing laser is on the bottom of said device to detect the distance of the device from a landing or takeoff surface, said at least one downwardly pointing laser being connected with onboard electronics to extend said legs when the device is within about 2 meters of the surface and to retract said legs when the device is more than about 2 meters from the surface.

9. The delivery device as claimed in claim 8, wherein:
there are four legs on the bottom of the device, said legs being spaced uniformly across said bottom; and
said at least one downwardly pointing laser comprises a downwardly pointing laser associated with each leg.

10. The delivery device as claimed in claim 9, wherein:
a lockable cover is on said body in covering relationship to said payload chamber.

11. The delivery device as claimed in claim 10, wherein:
a touchscreen is on said body, and said lockable cover is unlocked by entering a code on said touchscreen.

12. The delivery device as claimed in claim 11, wherein:
a hanger is on the bottom of said body for suspending objects too large for the payload chamber.

13. The delivery device as claimed in claim 12, wherein:
a removable cover is on the bottom of said body for gaining access to internal components.

14. The delivery device as claimed in claim 13, wherein:
said payload chamber and said lockable cover are insulated.

15. The delivery device as claimed in claim 14, wherein:
an onboard battery provides power to said device.

16. The delivery device as claimed in claim 14, wherein:
said battery is rechargeable; and
a port is on said body for plugging in a charger to recharge said battery.

17. The delivery device as claimed in claim 1, wherein:
legs are on the bottom of said device to support the device on a surface.

18. The delivery device as claimed in claim 17, wherein:
at least one downwardly pointing laser is on the bottom of said device to detect the distance of the device from a landing or takeoff surface, said at least one downwardly pointing laser being connected with onboard electronics to extend said legs when the device is within about 20 meters of the surface and to retract said legs when the device is more than about 20 meters from the surface.

19. The delivery device as claimed in claim 1, wherein:
a camera is on said device to record video during flight.

20. The delivery device as claimed in claim 19, wherein:
a touchscreen is on said device on which: the sender can write a massage to the recipient; the sender can choose whether to send the device roundtrip or one-way; the recipient can enter the security code to open the payload chamber; maps and the location of the recipient are displayed; the weather and battery charge level are displayed; and the video recorded during flight can be displayed.
